(19) United States
(12) Patent Application Publication
(10) Pub. No.: US 2006/0174721 A1
(43) Pub. Date: Aug. 10, 2006

(54) DIGITAL SCALE FOR LINEAR OR ROTARY STAGE

(75) Inventor: John C. Tsai, Saratoga, CA (US)

Correspondence Address: INTELLECTUAL PROPERTY LAW OFFICES, 1901 S. BASCOM AVENUE, SUITE 660, CAMPBELL, CA, 95008, US

(73) Assignee: Excel Precision Corporation, Santa Clara, CA (US)

(21) Appl. No.: 11/277,927

(22) Filed: Mar. 29, 2006

Related U.S. Application Data
(63) Continuation-in-part of application No. 10/707,487, filed on Dec. 17, 2003.
(60) Provisional application No. 60/434,759, filed on Dec. 17, 2002.

(51) Int. Cl. G01D 7/02

(52) U.S. Cl. 73/866.3

(57) ABSTRACT

A measurement system including a machine tool stage having a first piece and a second piece that are movable with respect to one another. A digital scale is integrated in the first piece and a detector is integrated in the second piece at a position suitable to detect movement with respect to the digital scale. The detector creates a signal based upon relative movement between the digital scale and the detector. A display integrated in the second piece receives the signal from the detector and displays a reading of the relative movement thus measured.

### CROSS-REFERENCE TO RELATED APPLICATIONS

This is a continuation-in-part of application Ser. No. 10/707,487, filed Dec. 17, 2003, which claims the benefit of U.S. Provisional Application No. 60/434,759, filed Dec. 17, 2002, and which are both hereby incorporated by reference in their entirety.

### TECHNICAL FIELD

The present invention relates generally to means for measuring between at least two relatively movable contact members, and more particularly to an indicating means including a transducer which is responsive to the contact member movement for producing in an electrical circuit an indication of the distance between the contact members.

### BACKGROUND ART

In many manufacturing and laboratory processes a very high number of machine tool stages are still measured by mechanical micrometer. Unfortunately, this poses a number of disadvantages. For example, micrometer reading requires interpretation with the human eye. The mechanically engraved scale is not only crude in displaying the measurement, but also quite difficult to read. The same displacement can produce different readings when the angle of observation changes. A more serious problem is that the mechanical micrometer has backlash and the clockwise and counterclockwise turning of the micrometer can therefore produce different readings even though the amount of actual displacement is the same. It is also very difficult to get micrometer readings when stages have to be operated in low light or dark conditions, as is necessary or highly desirable in some applications. FIG. 1 (prior art) provides examples of various linear stages with micrometers attached, and FIG. 2 (prior art) provides an example of a linear slide with multiple moving stages.

The shortcomings of the mechanically engraved scale are even more serious for a rotary stage, tilt stage, gimbal mount, or goniometer. Some rotary stages today are equipped with a mechanical micrometer on the side. The amount of the rotation is then measured by reading the scale on the micrometer, which is in a linear dimension, and this is then converted to an angular measurement. However, this is not only time consuming but often also highly inaccurate. For instance, when the rotation angle is large the cosine error becomes significant. FIG. 3 (prior art) provides examples of various rotary stages with engraved scales, and FIG. 4 (background art) depicts such a rotary stage with a mechanically engraved scale.

Digital scales have been used in mechanical stages and slides for some time. However, up to now, almost all of these require a separate signal detection unit, interface cable, and personal computer (PC) board. The displacement of the stage is then displayed on a computer screen. The cost of these stages is high, typically in the range of several thousand dollars to over ten thousand dollars for a single axis displacement stage. Integrated signal-and-display stages are not offered and it is especially notable that we know of no rotary stages equipped with a digital scale readout that are presently available.

### DISCLOSURE OF INVENTION

Accordingly, it is an object of the present invention to provide an improved digital scale for linear and rotary stages.

Briefly, one preferred embodiment of the present invention is a measurement system. A machine tool stage having a first piece and a second piece is provided, wherein at least one of these pieces is are movable with respect to the other. A digital scale in integrated in the first piece and a detector is integrated in the second piece at a position suitable to detect movement with respect to the digital scale and create a signal based upon this relative movement. A display integrated in the second piece then receives the signal from the detector and displays a reading of the relative movement.

An advantage of the present invention is that it provides an integrated signal-and-display stage.

Another advantage of the invention is that it employs electronic detection and display, thereby minimizing the human interpretation errors and mechanical errors that mechanical stages suffer from.

Another advantage of the invention is that it encompasses linear stages and slides as well as rotary stages, tilt stages, gimbal mounts, and goniometers.

Another advantage of the invention is that it may include functions such as position reset, position preset, position difference between a reference position and a measured position, and conversion between units of measurement.

And another advantage of the invention is that it is economical to construct and use.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended figures of drawings in which:

FIG. 1 (prior art) shows linear stage examples with mechanical micrometers attached;

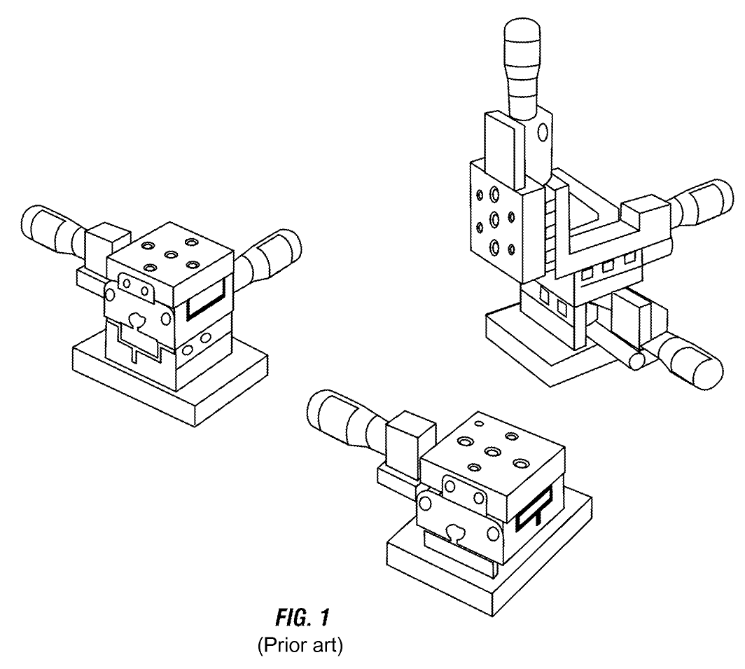

FIG. 2 (prior art) shows a linear slide example with multiple stages;

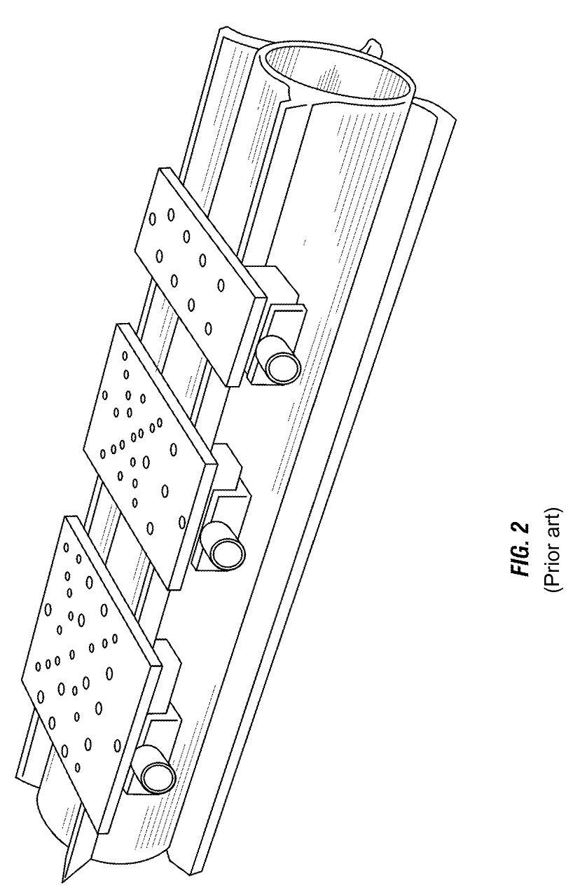

FIG. 3 (prior art) shows rotary stage examples with engraved scales on the side and mechanical micrometers;

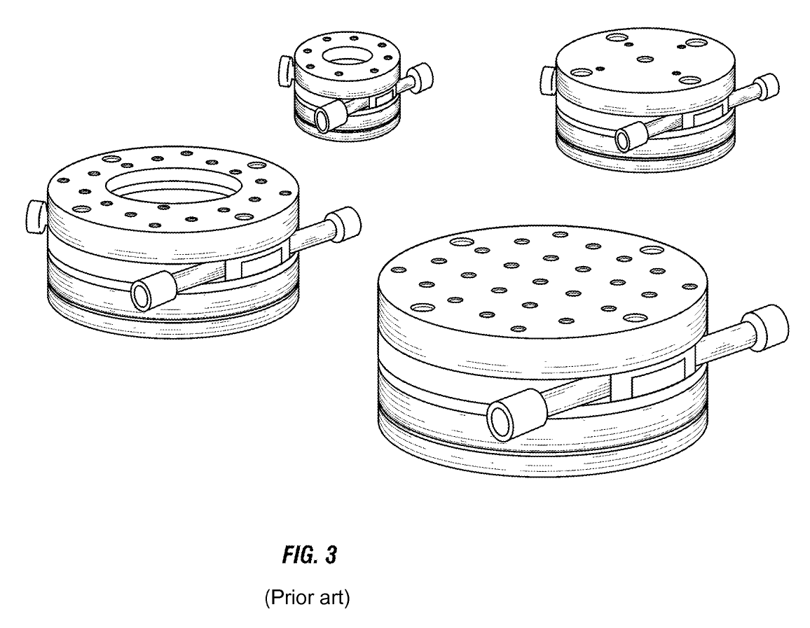

FIG. 4 (background art) shows a rotary stage example with a mechanically engraved scale on the sides;

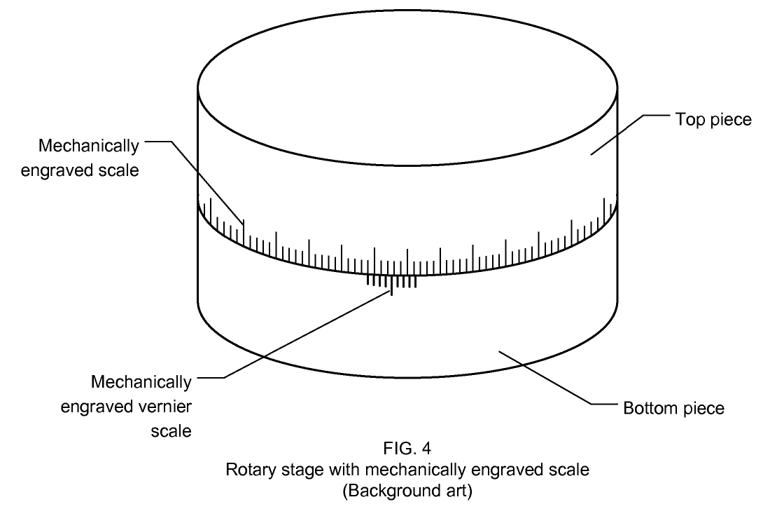

FIG. 5a-b shows an embodiment of a linear stage according to the present invention that is equipped with a digital scale, wherein FIG. 5a shows a top piece in left side and plan bottom views and FIG. 5b shows a bottom piece in left side, plan, and right side top views as well as in a front plan view;

FIG. 6 shows an embodiment of a rotary stage according to the present invention that is equipped with a linear digital scale attached at the edge of the stage; and

FIG. 7 shows an embodiment of a rotary stage according to the present invention that employs a digital disk mounted at the inner surfaces.

In the various figures of the drawings, like references are used to denote like or similar elements or steps.

### BEST MODE FOR CARRYING OUT THE INVENTION

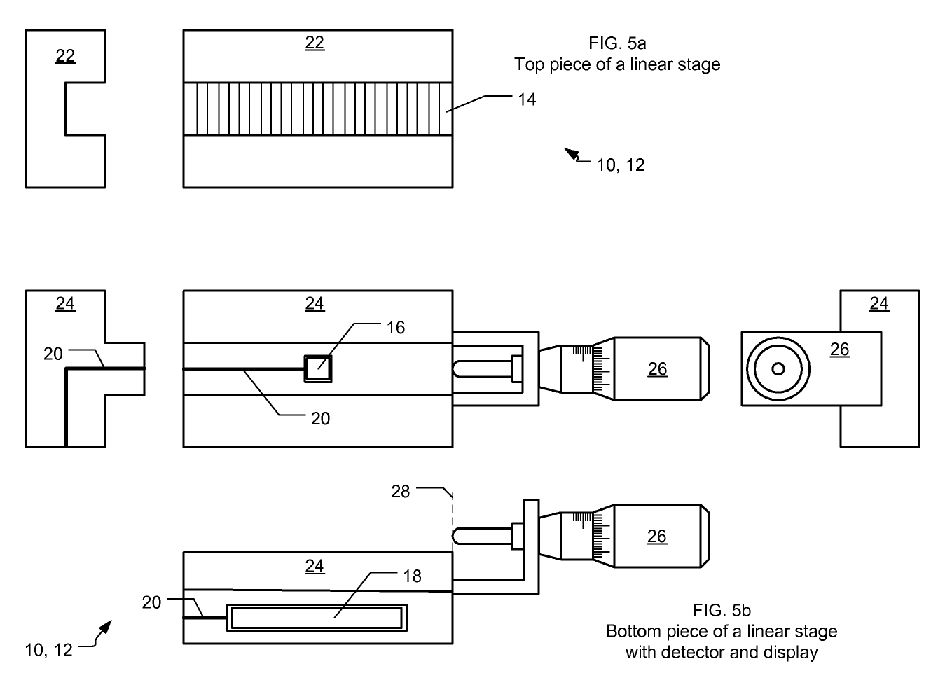

A preferred embodiment of the present invention is a digital scale for linear or rotary machine tool stages. As illustrated in the various drawings herein, and particularly in the views of FIGS. 5a-b, 6 and 7, preferred embodiments of the invention are depicted by the general reference character 10.

An objective way of getting the reading of a true position (or rotation) is to use a digitally reading scale with an integrated display. The principle of operation of such a scale can be either magnetic, holographic grating, inductive, or capacitive and, in general, can be embodied in a tape form factor. All of these examples of scales are accurate to within a few microns, and are presently available in the market. What is not available and for which there is a long standing and severely felt need, however, are stages with such scales and their displays integrated therein. Such can provide accurate measurement for the position of a linear stage or the rotation of a rotary stage, and thus overcome the numerous disadvantages of the prior art stages discussed above.

The digital scales used may be flexible and can be mounted very close to the axis of the motion, thus minimizing the Abbe offset error. These digital scales can also be mounted either at an outer or inner surface of the stage (either on a moving part or a stationary part), with the detector on the surface of a counterpart. Mounting on an inner surface has advantages from cosmetic and cleanliness points of view, and in some applications may provide a degree of protection against physical wear and damage. In addition, this reduces the chance for getting dust particles in between a scale and its detector.

FIG. 5a-b present various views of a stage 10 according to the present invention. The stage 10 here is a linear stage 12 that is equipped with a digital scale 14, a detector 16, and a display 18 which is connected with the detector 16 by a signal wire 20. The linear stage 12 can be defined as having a top piece 22 and a bottom piece 24. This definition is useful when considering the figures and the examples presented herein, but should not be taken to imply any form of limitation. Some purists hold that a “stage” is the portion of the mechanism that moves and that the stationary part of the mechanism is a base or basepiece. More generally, however, the total mechanism is spoken of as being a stage. This better encompasses the fact that both pieces, e.g., top and bottom, table and base, etc. may both move and that any measurement between them then is a relative measurement. This also helps avoid the incorrect implication that the a digital scale 14 is always placed in the moving “stage” and the detector 16 and display 18 are always placed in the “basepiece.”

Continuing with FIG. 5a-b, the top piece 22 in this embodiment includes the digital scale 14, and the bottom piece 24 includes the detector 16 and the display 18. An optional, conventional mechanical adjustable stop 26 is also shown here.

In use, the top piece 22 of the linear stage 12 here can be moved left or right, thus moving the digital scale 14 relative to the detector 16. The detector 16 then produces and sends a signal to the display 18 via the signal wire 20. The adjustable stop 26 can be used to set a rightmost position 28 for travel of the top piece 22. The display 18 can then be set to read zero when the top piece 22 is in the rightmost position 28, and the display 18 will display a relative measurement or displacement when the top piece 22 is moved away from the rightmost position 28.

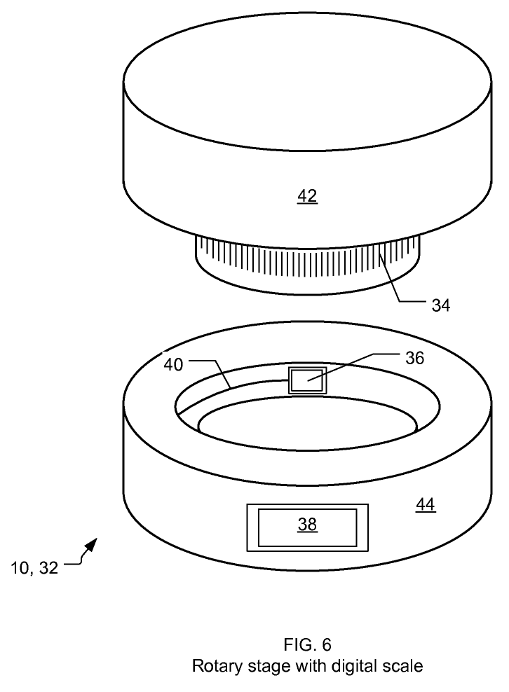

FIG. 6 presents another embodiment of a stage 10 according to the present invention. The stage 10 here is a rotary stage 32 that is equipped with a digital scale 34, a detector 36, and a display 38 which is connected with the detector 36 by a signal wire 40. This rotary stage 32 can also be defined as having a top piece 42 and a bottom piece 44, with the top piece 42 including the digital scale 34 and the bottom piece 44 including the detector 36 and the display 38.

In use, the top piece 42 of the rotary stage 32 here can be turned clockwise or counter clockwise, and in this embodiment the top piece 42 can even be revolved completely, many times, in either direction. This moves the digital scale 34 relative to the detector 36, causing the detector 36 to send a signal to the display 38 via the signal wire 40. Of course, the top piece 42 can also be held fixed and the bottom piece 44 be rotated, or both pieces 42, 44 can be rotated.

The detector 36 and the display 38 here can be the same as the detector 16 and the display 18 of the linear stage 12 in FIG. 5a-b, but this need not necessarily be the case. The detector 36 will, however, display measurements of angular position whereas the display 18 of the linear stage 12 will display measurements of linear position. The digital scale 34 here may even have close similarity to the digital scale 14 of the linear stage 12. For instance, as noted above, digital scales can be embodied in a tape or other flexible form factor. The digital scale 34 here can therefore be simply an encircling application of the very same component used in the digital scale 14 in flat application.

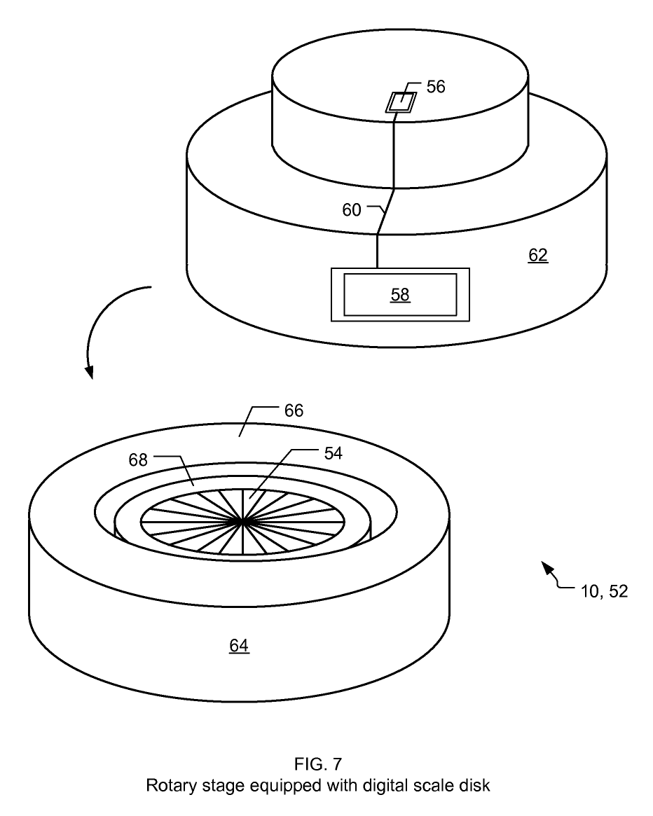

FIG. 7 presents yet another embodiment of a stage 10 according to the present invention. The stage 10 here is a rotary stage 52, but one using a different form of digital scale 54 than the digital scale 34 of the rotary stage 32 in FIG. 6. A detector 56 and a display 58 connected by a signal wire 60 are also provided here. The detector 56 necessarily is one suitable for use with the particular digital scale 54 here, but the display 58 may potentially be the same as the displays 18 and 38.

The rotary stage 52 here can also be defined as having a top piece 62 and a bottom piece 64. The top piece 62 here, show turned over to better depict its elements, includes the detector 56 and the display 58. The bottom piece 64 has an outer housing 66 and an inner race 68, and the inner race 68 includes the digital scale 54.

In use, either the top piece 62 or the inner race 68 (or both) can be turned clockwise or counter clockwise, possibly even revolved completely multiple times. This moves the digital scale 54 and the detector 56 relative to one another, causing the detector 56 to send a signal to the display 58 via the signal wire 60. The outer housing 66 of the bottom piece 64 may or may not move, as desired, with any such movement having no effect on the measurement being made between the top piece 62 and the inner race 68.

Considering the displays 18, 38, 58 now, these can be illuminated, permitting use in low light so users do not have to turn on a light to take a reading. They can also, optionally, allow users to preset an initial position as a reference, and to then measure displacement from this reference position, to reset a reference position with a targeted value and to measure the difference position from there (“+” direction and “−” direction, etc.), and to change between different units, e.g., millimeters or inches for linear displacement and degrees or radians for rotation measurement. Similarly, the display can change scales, e.g., millimeters to centimeters, degrees to minutes or seconds, and radians to milli-radians, etc.. The displays 18, 38, 58 can even further provide an input/output connector for the user to output the measured result to a computer, to load presets, to set units, etc. For example, the RS232 or other protocols can be used.

To achieve these, and potential other capabilities, the displays 18, 38, 58 use at least a limited microprocessor. The stage 10 also has access to a power source to power the detectors 16, 36, 56 and the displays 18, 38, 58. In the figures herein the microprocessor and power source have been treated as being integrated into the displays 18, 38, 58, as will typically be the case. This, however, need not necessarily be the case. The microprocessor can be located elsewhere in the stage 10, and connected to the detectors 16, 36, 56 and displays 18, 38, 58 in straightforward manner, and the power source can be located elsewhere in the stage 10 or even outside of it.

Without limitation, some suitable candidate types for the displays 18, 38, 58 are liquid crystal or light emitting diode (LED) based units. These typically have limited microprocessor capability already provided to handle their visual presentation role, and it is a simple matter to employ or to enhance this to also handle any other desired microprocessor roles as well.

Various suitable candidate types for the power source also exist. For example, also without limitation, batteries, local generation, and external sources may be employed. The batteries used for this may be replaceable, rechargeable, or permanent. For instance, replaceable or permanent (e.g., lithium based, long-life type) batteries will typically be best suited when used with low-power type displays 18, 38, 58, such as liquid crystal based units. Conversely, rechargeable batteries or other types of power sources will typically be best suited when used with higher-power type displays 18, 38, 58, such as LED based units.

Local generation of power is also suitable for use in some embodiments of the stage 10. Some examples here include photo generation cells, often called solar cells, but also usable in many other ambient light conditions, and movement based generation. Since the stage 10 is by its vary nature subject to movement, this may be used to generate the small amounts of power it needs. For instance, a coil and magnetic field can be used to form a generator, or a piezoelectric device and a storage mechanism, such as a capacitor, can be used.

External power sources may also be employed. One common example is conventional “plug into the wall” type sources. Another example is parasitic “leaching” of power from a system used in concert with the stage 10. For instance, it was noted above that an interface (e.g., RS232, USB, etc.) can be present and used to permit communication with an external computer. Power for the relatively minor needs of the stage 10 can be obtained from such an interface.

The particular design details of the microprocessors and the power sources are, of course, not critical to the underlying invention here, but we have gone into some detail on possible candidates for them to emphasize the invention's versatility and wide range of potential options.

While various embodiments have been described above, it should be understood that they have been presented by way of example only, and that the breadth and scope of the invention should therefore not be limited by any of the above described exemplary embodiments, but instead defined only in accordance with the following claims and their equivalents.

What is claimed is:

1. A measurement system, comprising:
a machine tool stage having a first piece and a second piece, wherein at least one of said first piece and said second piece are movable with respect to one another;
a digital scale integrated in said first piece;
a detector integrated in said second piece at a position suitable to detect movement with respect to said digital scale and create a signal based upon relative movement between said digital scale and said detector; and
a display integrated in said second piece and suitable to receive said signal from said detector and display a reading of said relative movement.

2. The measurement system of claim 1, wherein said stage is a linear translation stage.

3. The measurement system of claim 1, wherein said stage is a member of the set consisting of rotary stages and goniometers.

4. The measurement system of claim 1, wherein said stage includes a plurality of said first pieces that share a same said digital scale.

5. The measurement system of claim 1, wherein said stage includes a plurality of said first pieces that are collectively movable with respect to said second piece along a single axis or multiple axes.

6. The measurement system of claim 5, wherein said second pieces of said plurality of said stages each include a respective said detector and said display, thereby permitting measurement and display independently on each said stage.

7. The measurement system of claim 1, wherein said digital scale is in tape or disk form factor.

8. The measurement system of claim 1, wherein said stage moves linearly and said digital scale is in tape form factor and is mounted on a surface of said first piece along the axis of said relative movement.

9. The measurement system of claim 1, wherein said first piece moves rotationally and said digital scale is in tape form factor and is mounted on a surface of said first piece along a rotational arc of said relative movement.

10. The measurement system of claim 1, wherein said first piece moves rotationally and said digital scale is in disc form factor and is mounted co-axial with a rotational axis of said relative movement.

11. The measurement system of claim 1, wherein said digital scale has a characteristic detectable by said detector that is a member of the set consisting of magnetic, holographic, inductive, capacitive, optical hole patterns, and optical line patterns.

12. The measurement system of claim 1, wherein said detector tailors the signal using a member of the set consisting of filtration and amplification.

13. The measurement system of claim 1, wherein said detector converts said signal into a digital accumulative number of counts.

14. The translation measurement system of claim 1, wherein said display provides at least one function that is a member of the set consisting of position reset, position preset, position difference between a reference position and a measured position, and conversion between units of measurement.

15. The translation measurement system of claim 1, wherein:
said signal is a raw signal;
said display converts said raw signal to at least one display value and displays said display value; and
said display includes a port to communicate a result signal based on a said display value to a computerized outside system.

16. The translation measurement system of claim 1, further comprising a microprocessor that processes said signal from said detector before said display displays said reading.

17. The translation measurement system of claim 1, further comprising a power source for powering at least one of said detector and said display.

18. A measurement method, comprising the steps of:
(a) moving a least one of a first piece of a machine tool stage and a second piece of said machine tool stage with respect to one another;
(b) detecting movement of a digital scale integrated in said first piece with a detector integrated in said second piece, thereby detecting relative movement between said digital scale and said detector;
(c) creating a signal based upon said relative movement;
(d) communicating said signal to a display integrated in said second piece; and
(e) displaying a reading of said relative movement on said display.

19. A measurement system, comprising:
means for moving a least one of a first piece of a stage and a second piece of said machine tool stage with respect to one another;
means for detecting movement of a digital scale means integrated in said first piece with a detector means integrated in said second piece, thereby detecting relative movement between said digital scale means and said detector means;
means for creating a signal based upon said relative movement;
means for communicating said signal to a display means integrated in said second piece; and
means for displaying a reading of said relative movement on said display means.
